(19) United States
(12) Patent Application Publication
(10) Pub. No.: US 2015/0363083 A1
(43) Pub. Date: Dec. 17, 2015

(54) User Interface and Method for Adapting Semantic Scaling of a Tile

(71) Applicant: VOLKSWAGEN AG, Wolfsburg (DE)

(72) Inventors: Indra-Lena Kögler, Berlin (DE); Mathias Kuhn, Berlin (DE); Filip Piotr Chudzinski, Berlin (DE); Alexander Hahn, Braunschweig (DE); Sönke Petersen, Berlin (DE); Omer Yosha, Berlin (DE)

(21) Appl. No.: 14/739,801

(22) Filed: Jun. 15, 2015

(30) Foreign Application Priority Data
Jun. 13, 2014 (DE) 10 2014 211 342.3

(51) Int. Cl. G06F 3/0484; G06F 3/0481

(52) U.S. Cl. CPC G06F 3/04845; G06F 3/0481; G06F 2203/04806

(57) ABSTRACT

A user interface and a method for adapting semantic scaling of a tile to a display unit of a user interface are provided. The method includes displaying a first tile including a first plurality of command buttons, detecting a user command to enlarge the display of the first tile and in response thereto, displaying an enlarged display of the first tile including a second plurality of command buttons.

### CROSS-REFERENCE TO RELATED APPLICATIONS

The present application claims priority to Application No. 10 2014 211 342.3, filed in the Federal Republic of Germany on Jun. 13, 2014, which is expressly incorporated herein in its entirety by reference thereto.

### FIELD OF THE INVENTION

The present invention relates to a user interface and to a method for adapting semantic scaling of a tile on a display unit of a user interface. In particular, the present invention relates to a user-friendly display of functionalities and to their ergonomic operation.

### BACKGROUND INFORMATION

Conventionally, user interfaces have display units on which so-called tiles are able to be shown (e.g., as parts of a home screen). The tiles represent optically mutually delimited semantic units for accessing different functional groups and for displaying variable information in connection with the different functional groups. For example, a first tile may be allocated to a first functional scope, and when a user input is received, it can provide a multitude of information panels as well as command buttons, via which the user is able to operate the individual sub-functionalities of the functional group. However, a user may also associate a specific functionality (“favorite”) or the call-up of the particular functionality (e.g., “call home” or “(randomly) play favorite play list”) with a tile. A second tile, which represents a second functional group, may be displayed parallel to the first tile, which when selected by a user, makes it possible to display or operate corresponding sub-functionalities of the second functional group. The individual tile may already display a multiplicity of variable items of information of the allocated functional group, even without having become the target of a user interaction. When a tile is called up, unpracticed users frequently lose track of where they are currently located in the menu of the user interface. In particular, it may be difficult for users to intuitively carry out the operating steps required for a return to the home screen.

European Published Patent Application No. EP 1 959 337 A1 describes a user terminal and a method for displaying an interactivity menu, in which a zoom functionality is employed in order to increase or decrease the number of icons displayed on a display. Icons already displayed before the zoom functionality was executed will be shown in enlarged form once the zoom functionality has been activated.

It is an object of example embodiments of the present invention to make the navigation in a tile-based menu more comfortable.

### SUMMARY

A user terminal, a computer program product, as well as a signal sequence and a means of locomotion are proposed for achieving the aforementioned objective. The method of the present invention is intended to adapt semantic scaling of a tile on a display unit of a user interface. In contrast to conventional semantic scaling when executing a zoom functionality, a first number of tiles is displayed to begin with, of which at least one first tile enables a first plurality of command buttons for direct access to functionalities associated with the command buttons. In a second step, a user command is detected for the larger size display of the first tile (“zoom in”). In response, the first tile is shown in an enlarged view in a third step and displayed with a second plurality of command buttons, which differs from the first plurality, for access to functionalities associated with the command buttons. In other words, because of the second plurality of command buttons, the number of possible direct accesses to functionalities associated with the first tile is higher. Due to the zoom-in, however, the user does not lose the mental reference to the original display of the first tile (and possibly additional tiles), which increases the user acceptance and obviates a search for command buttons for a return to the original display. Especially when the user interface of the present invention is used in a means of locomotion, it is therefore possible to reduce the distraction potential that is invariably inherent in the user interface. This increases the road safety of means of locomotion equipped according to example embodiments of the present invention.

The method according to example embodiments of the present invention may preferably be developed further in that a second tile, which includes a third plurality of command buttons, is shown on the display unit in addition to the first tile, and in response to the detection of the previously described user command, the second tile is displayed in enlarged form as well, and the third plurality of command buttons is increased to a fourth plurality of command buttons. This enables a user to access more sub-functionalities of two functional groups that are shown in parallel on the display unit (associated with, respectively, the first and second tile).

In the same way it is optionally provided in example embodiments of the present invention to detect a user command for the reduced-size display of the first tile (and, provided it is displayed, a second tile as well) and in response thereto, to display the first tile (and the possibly shown second tile) at a reduced size and with a reduced fifth number of command buttons. This allows an additional, simultaneous display of further tiles and thus direct access to additional functional groups.

The number of displayed command buttons preferably rises as the size of the displayed tile(s) becomes larger. In particular, the second plurality is greater than the first plurality, and alternatively or additionally, the fourth plurality is greater than the third plurality. Depending on the selected size of the first tile following the reduced-size display, the fifth plurality may be greater or smaller than the first plurality. This ensures an always comfortable display and easy access to the command buttons, regardless of the displayed size of the tile.

The user command for the enlarged or reduced size display of the individual tile may encompass the actuation of a command button shown on the display unit. The command button, for example, may be displayed on a particular tile itself, so that a call-up of the tile and the input of a command for its enlarged display are combinable. As an alternative or in addition, a command button superordinate to all tiles may be actuated, which, for instance, displays the tile or the plurality of tiles shown in a predefined region on the home screen in an enlarged view according to the present invention. As an alternative or in addition, a previously activated tile is displayable in a larger size by actuating the superordinate command button. Tiles possibly located adjacently may be shown in enlarged form as well and displayed in parallel with the enlarged first tile. A finger spreading gesture for the enlarged display or a pinching gesture for the reduced size display of the tiles may be used as an alternative or in addition. Such gestures are able to be performed on touch-sensitive surfaces or freely in space, provided the particular user interface is set up to recognize such gestures. As an alternative or in addition, what is referred to as a dual-tap gesture (dual touching within a short period of time) may be executed in order to enlarge the display of a first tile (and possibly additional tiles) of a home screen according to the present invention. The dual-tap gesture, as well, is able to be executed and detected on a touch-sensitive surface, on an operating element provided as an alternative thereto, or freely in space in the form of a 3D gesture.

In the enlarged display of the viewed tile it is preferably provided to display additional command buttons in connection with all command buttons displayed previously already. In this way the command buttons previously available on the viewed tile as well as direct accesses to the functionalities associated therewith remain available even after the enlarged display. This increases the operating ergonomics and thus the user acceptance.

A particular tile of a functional group shown on the home screen is preferably allocated from the following subject areas, and preferably no two tiles are allocated to an identical subject area:
audio and/or video reproduction
climate control
heating
on-board computer
ambient light
points of interest in the vicinity
navigation
address book
telephony
text messages
a reference to a display of a screen content of an external user terminal.

The enlarged display of the first tile in response to the user input may preferably include an optically essentially continuous enlargement of the tile(s). This increases the user comprehension in the form of a greater visual relationship between the output display and the original display and the enlarged display. The reduced-size display may likewise correspondingly include an optically continuous down-sizing of the tile(s). This measure not only provides better user orientation, but also increases the user's joy of use.

According to an example embodiment of the present invention, a method for displaying a menu bar on a display unit of a user interface is proposed, especially of a means of locomotion. The method includes the steps of displaying a home screen on the display unit, detecting a wiping gesture, especially in the form of a 3D gesture executed freely in space or a touching gesture on a touch screen, and in response thereto, displaying the menu bar. The wiping gesture is preferably not allocated to any tile of the home screen. Furthermore, the wiping gesture may start at the edge or outside the edge of the display unit and be directed toward the center of the display unit. Prior to its appearance, the location where the menu bar appears may be occupied or unoccupied (black background, wallpaper, etc.). The menu bar may extend along an edge of the display unit. The menu bar can be used for the creation of new tiles or for a new allocation of functionalities to already existing tiles. In addition, functionalities that are not associated or not associable with tiles may be accessed via the menu bar. Possible functional areas to which the command buttons or (depending on the size) also tiles of the menu bar are allocated are
audio and/or video reproduction (“media”)
climate control
heating
on-board computer
ambient light
points of interest in the vicinity
navigation
address book
telephony
text messages
a reference to a display of a screen content of an external user terminal.

According to an example of embodiment of the present invention, a user interface is proposed which includes a display unit and an input unit. The display unit is designed to display a first tile which includes a first plurality of command buttons, while the input unit is designed to detect a user command for the enlarged (or reduced size) display of the first tile (or additional tiles). In response, the display unit is set up to display the first tile, which includes a second plurality of command buttons. The display of the second plurality of command buttons makes it possible to implement more direct accesses with regard to the functional group represented by the first tile. In other words, the user interface according to the present invention is designed to realize the features, feature combinations and the resulting advantages in accordance with the afore-described method, so that reference is made to the pertinent statements in order to avoid repetitions.

According to an example embodiment of the present invention, a user terminal is proposed which, for instance, may be developed as a notebook, netbook, ultrabook, tablet, smartphone or other mobile wireless communications device. According to an example of embodiment of the present invention, the user terminal includes a user interface as described in detail in connection with the second aspect as the invention. The features, feature combinations and advantages result accordingly.

According to an example of embodiment of the present invention, a non-transitory computer program product (such as a data memory, for instance) is proposed, on which instructions are stored that enable a programmable processor to execute the steps of a method as recited in the first aspect of the invention. The computer program product may be developed as a CD, DVD, blue-ray disk, flash memory, hard disk, RAM/ROM, cache, etc.

According to an example of embodiment of the present invention, a means of locomotion is proposed, which may be realized as a passenger car, a commercial van, a truck, an aircraft and/or watercraft. The means of locomotion includes a user terminal developed according to an example embodiment of the present invention, as described in detail herein. The features, feature combinations and advantages result accordingly.

### BRIEF DESCRIPTION OF THE DRAWING

Exemplary embodiments of the present invention are described in detail below with reference to the accompanying drawing.

FIG. 1a is a schematic representation of an exemplary embodiment of a means of locomotion according to the present invention, including components of an exemplary embodiment of a user interface according to the present invention.

FIG. 1b is a schematic representation of an exemplary embodiment of a user terminal according to the present invention, including components of an exemplary embodiment of a user interface according to the invention.

FIG. 2 is a screen shot of an exemplary home screen including tiles.

FIG. 3 is a screen shot of an exemplary enlarged display of a tile shown on the home screen according to FIG. 2.

FIG. 4 is a screen shot of an exemplary home screen.

FIG. 5 is a screen shot of an exemplary enlarged display of a tile included on the home screen according to FIG. 4.

FIG. 6 is a screen shot of an exemplary enlarged display of a further tile included on the home screen according to FIG. 4.

FIG. 7 is a flow chart illustrating the steps of an exemplary embodiment of a method according to the present invention.

FIG. 8 is a diagram illustrating a user interaction with a user interface according to an embodiment of the present invention.

FIG. 9 is an image sequence which illustrates user interactions with a user interface according to an embodiment of the present invention.

### DETAILED DESCRIPTION

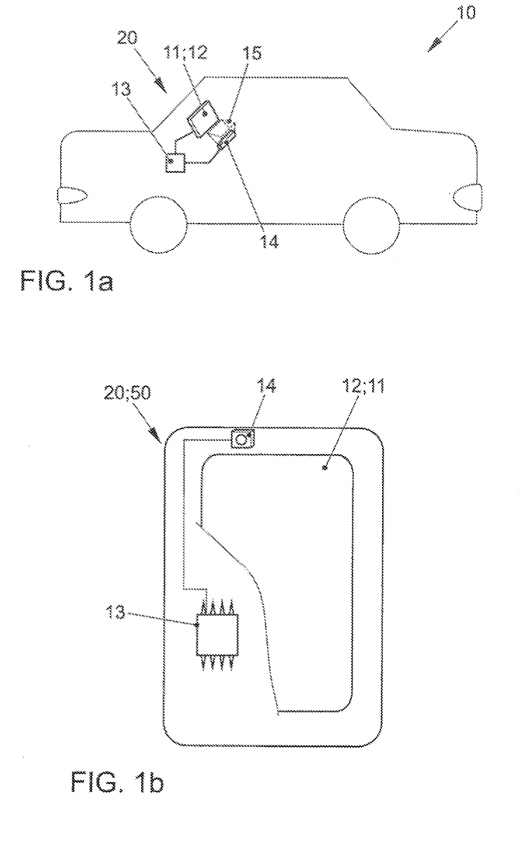

FIG. 1a shows a passenger car 10 as an exemplary embodiment of a means of locomotion according to an example embodiment of the present invention, which includes components of a user interface 20 according to an exemplary embodiment of the invention. An electronic control unit 13 (which includes a programmable processor) is provided as evaluation unit and connected for the exchange of information to a screen 11 as display unit, which includes a touch-sensitive surface 12 and an infrared LED bar 14 as input unit. Infrared LED bar 14 defines a 3D detection range 15, via which user inputs freely executed in space are detected and able to be allocated to command buttons displayed on screen 11.

FIG. 1b shows a tablet 50 according to an exemplary embodiment of a user terminal of the invention, which includes an exemplary embodiment of a user interface 20 according to the invention. A programmable processor 13 serves as evaluation unit and is connected for the exchange of information with a screen 11 as display unit, and with an optical camera 14 and a touch-sensitive surface 12 as input unit.

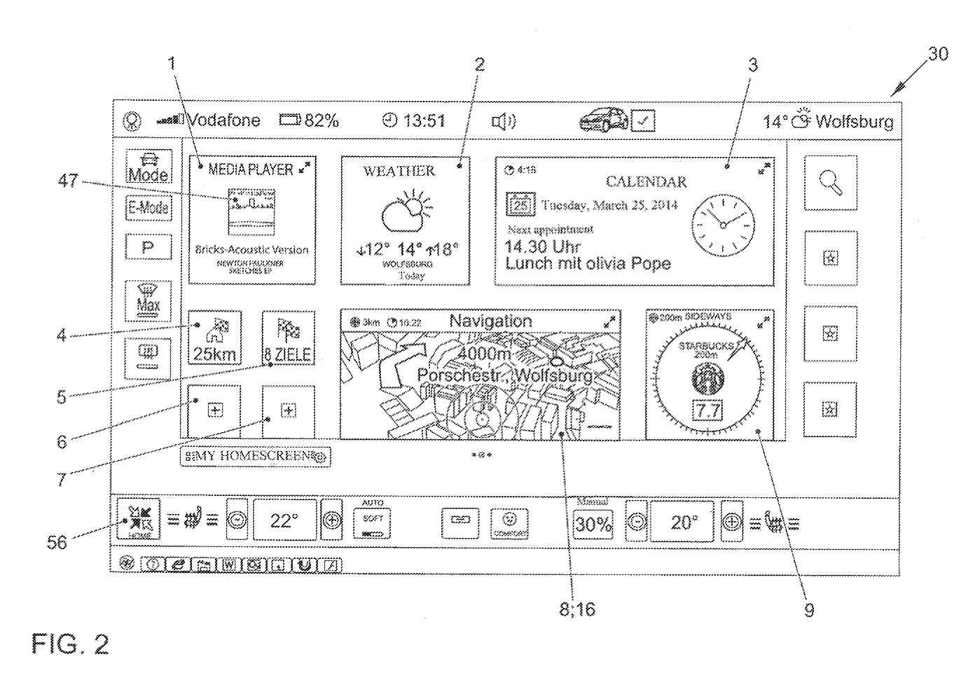

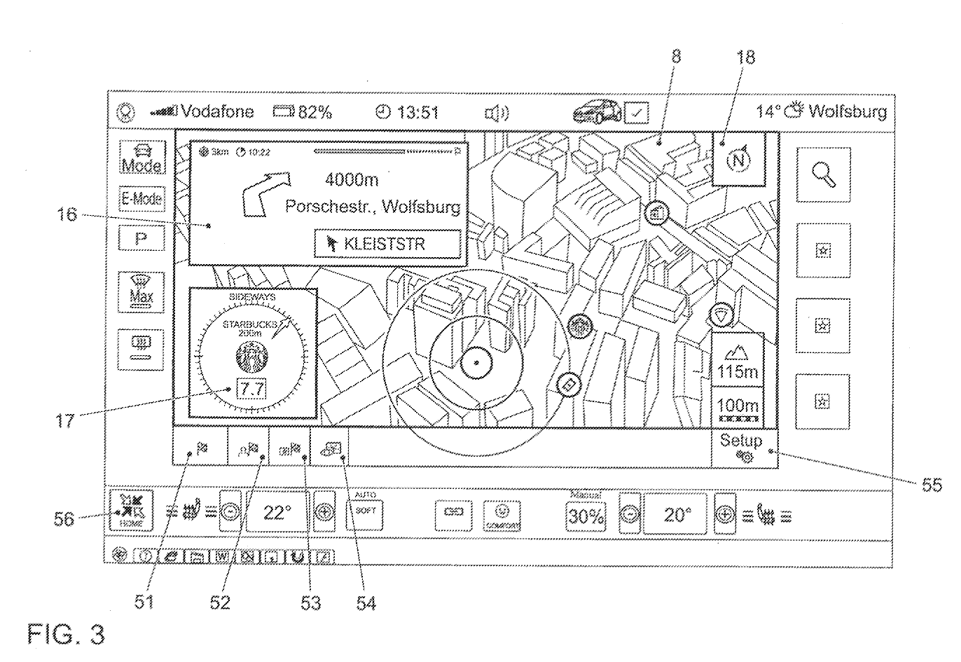

FIG. 2 depicts a screen shot of a home screen 30 on which tiles 1, 2, 3, 4, 5, 6, 7, 8, 9 representing different functional groups are shown. By way of example, a tile 1 is allocated to music playback and has a single command button 47 in the form of an album cover as a first plurality of command buttons. Via a user interaction with command button 47, the user is able to start the music playback and to stop it by a repeat interaction. A tile 8 has a command button 16 in the form of a perspective town view as a first plurality of command buttons, whose operation causes a most recent navigation command to be output again. In addition, home screen 30 includes a command button 56, superordinate to tiles 1, 2, 3, 4, 5, 6, 7, 8, and 9 for implementing a zoom-out (reducing) functionality or a zoom-in (enlarging) functionality in order to reduce or enlarge the display size of a particular tile and in so doing, to increase or reduce the command buttons displayed on the particular tile according to an example embodiment of the present invention. By executing a zoom-in gesture, the user obtains a screen view shown in FIG. 3.

FIG. 3 shows an enlarged view of tile 8, which is now the sole tile of home screen 30. According to an example embodiment of the present invention, the enlarged display allows an increase in the number of command buttons 16, 17, 18, 51, 52, 53, 54, 55 shown on tile 8. For example, command button 16 essentially corresponds to the display of tile 8 shown in FIG. 2 (with the exception of the perspective city view). An interaction with this command button 16 induces the navigation system to output the most recently given navigation command via loudspeakers (not shown). Apart from its header line, command button 17, which has been added, is similar to tile 9 of home screen 30. A user interaction with command button 17 delivers additional information pertaining to a close-by café and allows the definition of a corresponding intermediate destination for the traveled route. The remaining command buttons 51, 52, 53, 54, 55 are allocated to other sub-functionalities of the functional group “navigation”.

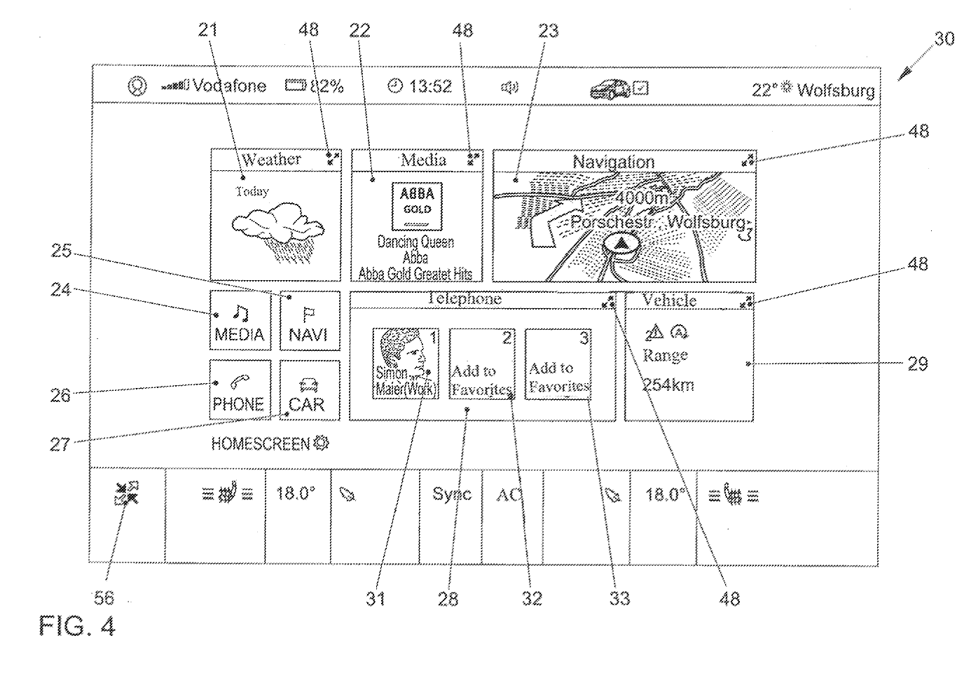

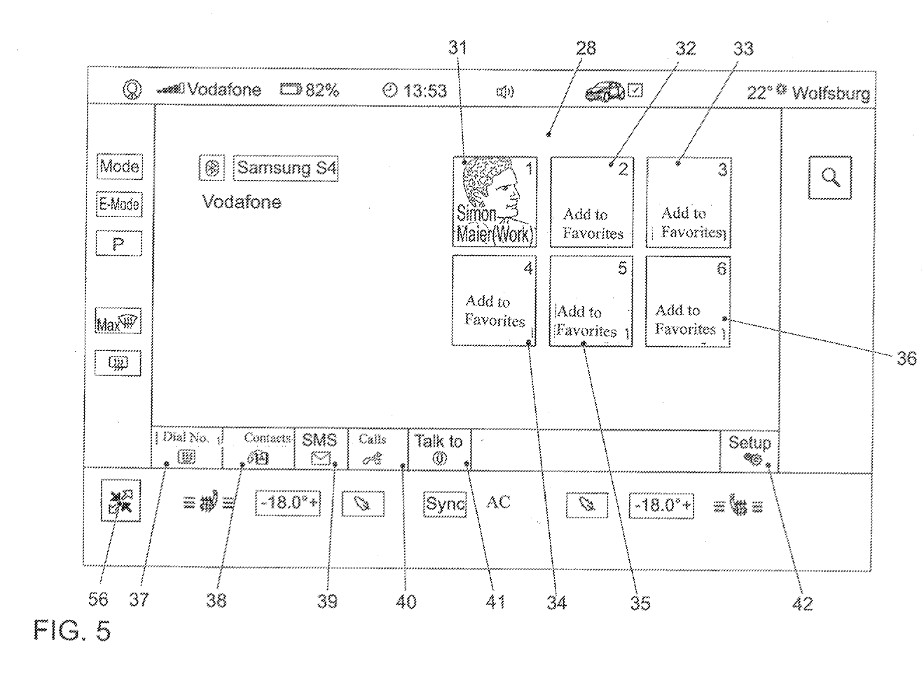

FIG. 4 shows an alternative view of a home screen after a user has approached a detection range. In response to the approach of the detection range, command buttons 48 in the title bars of tiles 21, 22, 23, 28 and 29 are shown in emphasized manner for the larger-size display of individual tile 21, 22, 23, 28, 29 in order to inform the user of the possibility of the enlarged display. Tiles 24, 25, 26, 27 shown in smaller size have no title bar, on the other hand. Tile 21 includes no command button in the illustrated display. In contrast, tile 28 has three command buttons 31, 32, 33, by which favorites can be added to or called up from the functional group “telephone”. When command button 48 of tile 28 is operated, the display shown in FIG. 5 is produced.

FIG. 5 shows a screen shot of a screen view produced in response to the enlarged display of tile 28. The plurality of command button 31, 32, 33 has been supplemented by three additional panels 34, 35, 36 for adding further favorites, and by command buttons 37, 38, 39, 40, 41, 42 for calling up additional sub-functionalities related to functional groups.

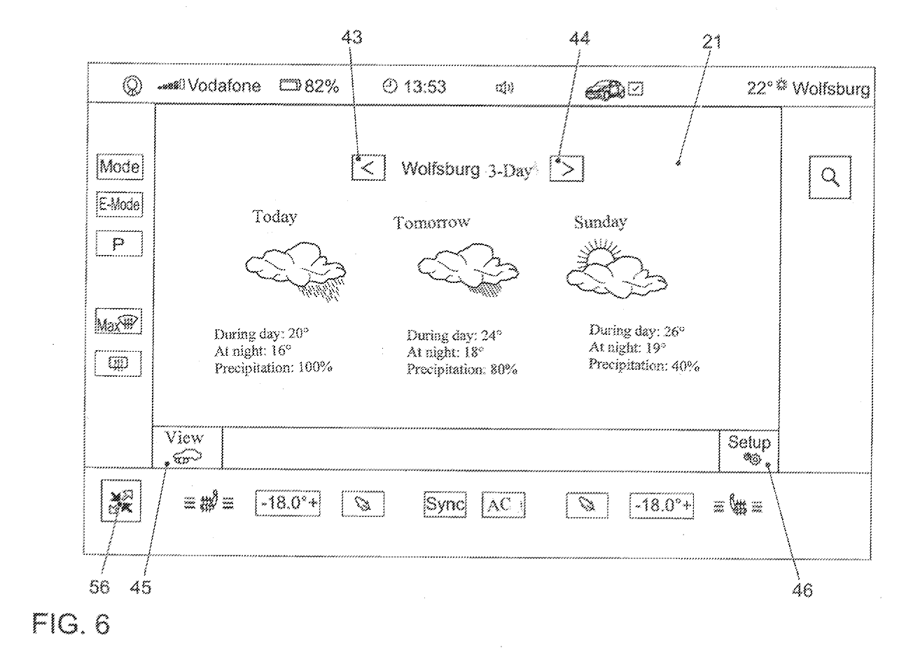

FIG. 6 shows a screen shot of an enlarged view of tile 21 generated in response to an interaction with symbol 48 of tile 21 (see FIG. 4). It displays a 3-day weather forecast, which has two command buttons 43, 44 for the display of previously not shown daily forecasts, and two additional command buttons 45, 46 for access to functionalities that are associated with the displayed functional group.

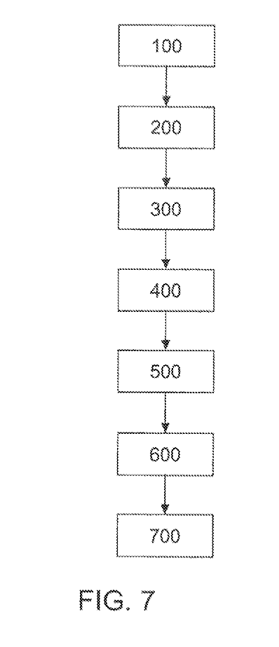

FIG. 7 shows steps of an exemplary embodiment of a method according to the present invention for adapting semantic scaling of a tile to a display unit of a user interface. In a first step 100, a first tile including a first plurality of command buttons is shown, and in a second step 200, a second tile is shown which includes a third plurality of command buttons. In step 300, a user command for the enlarged display of the first tile is detected, whereupon the first tile including a second plurality of command buttons is shown in an enlarged view in step 400. Accordingly, in step 500, the second tile including a fourth plurality of command buttons is shown in an enlarged view. In step 600, a user command for the reduced size display of the first tile is detected, whereupon the first tile, which includes a fifth plurality of command buttons that differs from the first and the third pluralities, is shown in step 700.

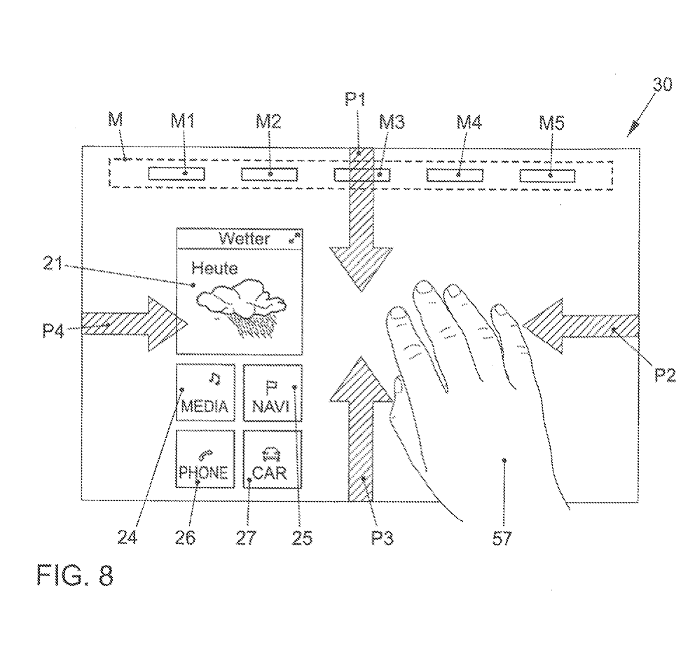

FIG. 8 shows a home screen 30, which corresponds to the configuration shown in FIG. 4. No menu bar M is provided in order to present the user with the most uncluttered screen view possible at times when no interaction is desired. In response to the execution of a wiping gesture by hand 57 of the user along one of arrows P1, P2, P3, P4 shown for the purpose of illustration, a menu bar M appears, which includes a plurality of command buttons M1, M2, M3, M4, M5. Via command buttons M1, M2, M3, M4, M5, tiles already displayed may be assigned new functionalities, or new tiles may be set up and functionalities be accessed which have not as yet been associated with tiles displayed on home screen 30.

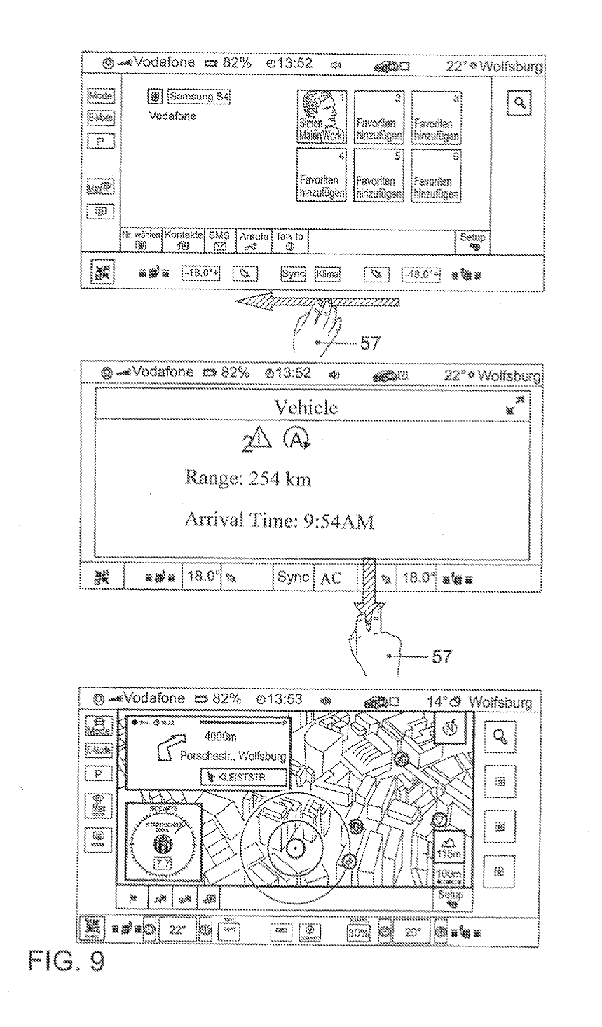

FIG. 9 shows an image sequence which illustrates exemplary user interactions starting from a view of the user interface already shown in connection with FIG. 5. In response to the execution of a horizontal wiping gesture toward the left by hand 57 of the user, a full view of the vehicle functionalities associated with tile 29 will be displayed. If a vertical wiping gesture in the downward direction is performed, the user subsequently arrives at the view shown in connection with FIG. 3. The wiping gesture, for example, may be performed using a predefined minimum number of fingers (e.g., one, two, three, four or five fingers) while making contact with the user interface. As an alternative, a 3D gesture may be performed, detected and used as an occasion for the afore-described switch between the full image displays. The sequence of the full image displays results in connection with the executed wiping gestures from FIG. 4. Starting from the telephone functionality, the wiping gesture executed toward the left results in the display of the vehicle functionalities, because the vehicle functionalities are disposed to the right, next to the telephone functionalities, on home screen 30. Starting from the vehicle functionalities, the user arrives at the navigation view by executing a wiping gesture toward below, because the navigation is shown above the vehicle functionalities on home screen 30. Nevertheless, the afore-described relationship between the wiping gesture directions and the placement of the tiles on home screen 30 represents an example and could be defined differently (e.g., by the user).

Even though the aspects according to the present invention and advantageous embodiments have been described in detail with the aid of the exemplary embodiments explained in connection with the attached drawing figures, modifications and combinations of features of the exemplary embodiments shown are possible for one skilled in the art, without leaving the scope of the present invention, whose range of protection is specified by the attached claims.

### LIST OF REFERENCE NUMERALS

| | |
|---|---|
| 1, 2, 3, 4, 5 | tiles |
| 6, 7, 8, 9 | |
| 10 | means of locomotion |
| 11 | screen |
| 12 | touch-sensitive surface |
| 13 | processor/evaluation unit |
| 14 | optical camera or infrared LED bar |
| 15 | detection range |
| 16, 17, 18, 19 | command buttons |
| 20 | user interface |
| 21, 22, 23, 24, 25, | tiles |
| 26, 27, 28, 29 | |
| 30 | home screen |
| 31, 32, 33, 34, 35, | command buttons |
| 36, 37, 38, 39, 40, | |
| 41, 42, 43, 44, 45, | |
| 46, 47 | |
| 48 | command button for the enlarged display |
| 50 | tablet |
| 51, 52, 53, 54, 55 | command buttons |
| 56 | command button for the global change of the |
| | display size |
| 57 | user hand |
| 100-700 | method steps |
| M | menu bar |
| M1-M5 | command buttons |

What is claimed is:

1. A method for adapting semantic scaling of a tile on a display unit of a user interface, the method comprising:
displaying a first tile including a first plurality of command buttons;
detecting a user command to enlarge display of the first tile; and
in response to the detected user command, displaying an enlarged display of the first tile including a second plurality of command buttons.

2. The method according to claim 1, further comprising:
displaying a second tile including a third plurality of command buttons on the display unit in addition to the first tile; and
in response to the detected command, displaying an enlarged display of the second tile including a fourth plurality of command buttons.

3. The method according to claim 1, further comprising:
detecting a user command to reduce display size of the first tile; and
in response to the detected command to reduce display size, displaying a reduced size display of the first tile including a fifth plurality of command buttons.

4. The method according to claim 1, wherein the second plurality is greater than the first plurality.

5. The method according to claim 1, wherein the fourth plurality is greater than the third plurality.

6. The method according to claim 1 wherein the user command is detected by one of: the actuation of a command button shown on the display unit, the execution of a finger-spreading gesture, the execution of a double tap gesture, or the actuation of a command button displayed on the first tile.

7. The method according to claim 1 wherein the user command for to enlarge or reduce display of the first tile is detected by actuation of a command button superordinate to the first tile.

8. The method according to claim 1, wherein the first tile is part of a home screen.

9. The method according to claim 3, wherein functionalities operable via the fifth plurality of command buttons are also operable via the second plurality of command buttons

10. The method according to claim 2, wherein functionalities operable via the third plurality of command buttons are also operable via the fourth plurality of command buttons.

11. The method according to claim 2, wherein the first tile represents a first functional group, the second tile represents a second functional group, and the plurality of command buttons represent individual selections from functionalities defined for the functional groups.

12. The method according to claim 11, wherein the functional groups are selected from the group consisting of audio and/or video reproduction, climate control, heating, on-board computer, ambient light, points of interest in the vicinity, navigation, address book, telephony, and text messages.

13. The method according to claim 1, wherein the enlarged display includes an optically continuous enlargement of the first tile

14. The method according to claim 3, wherein the reduced size display includes an optically continuous down-scaling of the first tile.

15. A system comprising:
a display unit to display a first tile including a first plurality of command buttons; and
an input unit to detect a user command to enlarge the display of the first tile;
wherein in response to the detected user command, the display unit displays the first tile including a second plurality of command buttons.

16. The system of claim 15 wherein the system is a mobile wireless communications device.

17. The system of claim 15 wherein the system is a means of locomotion, in particular a vehicle, preferably a passenger car, a commercial van, a truck, an aircraft or a watercraft.

18. A non-transitory computer readable medium including instructions which when executed on a programmable processor, induce the processor to carry out the steps of a method, the method comprising:
displaying a first tile including a first plurality of command buttons;
detecting a user command to enlarge display of the first tile; and
in response to the detected user command, displaying an enlarged display of the first tile including a second plurality of command buttons.

19. The non-transitory computer readable medium according to claim 18, the method further comprising:
displaying a second tile including a third plurality of command buttons on the display unit in addition to the first tile; and
in response to the detected command, displaying an enlarged display of the second tile including a fourth plurality of command buttons.

20. The method according to claim 18, further comprising:
detecting a user command to reduce display size of the first tile; and
in response to the detected command to reduce display, displaying a reduced size display of the first tile including a fifth plurality of command buttons.
